(19) United States
(12) Patent Application Publication
(10) Pub. No.: US 2004/0247193 A1
(43) Pub. Date: Dec. 9, 2004

(54) Method and apparatus for article inspection

(76) Inventors: Paul Thomas Qualtrough, Onehunga (NZ); Arron James Porter, Cambridge (NZ)

Correspondence Address: PAUL, HASTINGS, JANOFSKY & WALKER LLP, P.O. BOX 919092, SAN DIEGO, CA, 92191-9092, US

(21) Appl. No.: 10/799,906

(22) Filed: Mar. 12, 2004

Related U.S. Application Data
(63) Continuation of application No. PCT/NZ02/00181, filed on Sep. 13, 2002.

(30) Foreign Application Priority Data
Sep. 13, 2001 (NZ) 514187

(51) Int. Cl. G06K 9/00

(52) U.S. Cl. 382/243

(57) ABSTRACT

The present invention relates to an article inspection apparatus. The apparatus includes conveying means (6) for conveying an article (5) through an inspection site (I) and rotating the article (5) about an axis (F). The article (5) is viewed by an imaging system including a first and a second image capture means (1A, 1B) and a mirror arrangement (7, 8) that defines the field of view of said first and second image capture means (1A, 1B). The imaging system is arranged so that the first image capture means (1A) has a field of view including a top view and a first upper side view of an article (5) on said conveying means (6) and the second image capture means (1B) has a field of view including a top view and second upper side view of said article (5), wherein said second upper side view opposes said first upper side view. Multiple lanes arranged side by side may be provided and lighting that provides substantially uniform light over the article (5) is also provided.

### TECHNICAL FIELD

This invention relates to a method and apparatus for inspecting the surface of articles and in particular, but not exclusively to a method and apparatus for the surface inspection and subsequent grading of fruit.

### BACKGROUND ART

Processing lines for articles such as fruit often require different quality articles to be separated. This is an important commercial function, which may be used for example, to distinguish between fruit destined for export and fruit destined for the local market. Manually grading articles is costly, slow and prone to inaccuracies. Thus, automated methods and apparatus for grading articles have been developed.

The use of one or more video cameras is one known method of automatically sensing characteristics of articles. For example, the method and apparatus described in the specification of U.S. Pat. No. 4,825,068 (Suzuki) uses a video camera in conjunction with mirrors to obtain a picture of each article as it travels past the line of sight of the mirrors. The mirrors enable a larger portion of the article, which is typically generally spherically shaped, to be simultaneously viewed by the camera, but some portion of the article remains obscured from view.

The mirror arrangement described in U.S. Pat. No. 4,825,068, is large, increasing the complexity and cost and reducing the reliability of the system. Also, the mirrors located for viewing the side of the fruit are substantially level with the fruit, leading to an increased chance of inaccuracies due to contamination on the surface of the mirrors or on their protective casing, if any.

Another problem of using video detection is the high cost of using video cameras. To reduce the capital cost of imaging systems, the number of cameras should be minimized. The optical inspection apparatus described in U.S. Pat. No. 5,917,926 (Leverett) uses two video cameras, one positioned above and one positioned below the fruit being inspected. A combination of mirrors is described to increase the field of view of each camera so as to minimize the obscured portion of the fruit. However, the part of the fruit in contact with the conveyor remains obscured.

A problem with optical detection of surface properties of generally spherical objects is that the image quality degrades for portions of the image removed from the optical axis. Thus, it is advantageous to have many fields of view, each covering a small area in order to reduce the adverse effects caused by the curved viewing surface. Also, optical detection requires the article to be lit. Variations in lighting over the surface of the article can lead to incorrect detection of surface characteristics, particularly when analyzing colour, as it becomes difficult to distinguish between bright patches caused by lighting and lighter coloured patches on the article itself.

Thus, it is an object of the present invention to overcome or ameliorate problems in article inspection apparatus at present by providing a method and apparatus for article inspection that allows substantially all the surface of an article to be inspected, reduces errors due to article surface curvature and/or which is cost efficient, or at least to provide the public with a useful alternative.

Further objects of the present invention may become apparent from the following description.

Throughout this specification, any reference to items of prior art is in no way to be deemed an admission that such prior art constitutes part of the common general knowledge.

### SUMMARY OF THE INVENTION

According to a first aspect of the present invention, there is provided an article inspection apparatus including:

conveying means for conveying an article through an inspection site and rotating the article about an axis of rotation as it passes through the inspection site;

an imaging system including a first and a second image capture means and a mirror arrangement that defines the field of view of said first and second image capture means, the imaging system arranged so that the first image capture means has a field of view including a top view and a first upper side view of an article on said conveying means and the second image capture means has a field of view including a top view and second upper side view of said article, wherein said second upper side view opposes said first upper side view.

Preferably, the first and second image capture means are spaced apart along the direction of travel of the conveying means.

Preferably, the article inspection apparatus includes processing means to analyze images received from the first and second image capture means, the processing means analyzing segments of the top view of the article from images captured at different stages of rotation of the article, the segments having dimensions so as to substantially avoid any overlap between segments.

Preferably, the field of view of the first image capture means overlaps with the field of view of the second image capture means along the conveying means to an extent sufficient to enable the processing means to identify in the view of the second image capture means the last segment analyzed from the first image capture means, and in this way identify an appropriate first segment to analyze from images from the second image capture means so that a substantially continuous picture of the surface of the article results by combining analyzed segments from the first and second image capture means.

Preferably, the extent of overlap is substantially the minimum to maintain said continuous picture of the surface of the article.

Preferably, the processing means alters the dimensions of either or both of the last segment from the first image capture means and the first segment from the second image capture means in order to maintain said continuous picture of the surface of the article.

Preferably, the article inspection apparatus includes processing means operable to receive plural images from said first and second image capture means and from said plural images identify a marking on the article, wherein the processing means then selects an image of said marking for analysis purposes according to predetermined criteria.

Preferably, the conveying means rotates the article at a speed so that it completes at least one complete revolution, but less than two complete revolutions while within combined fields of view of the first and second image capture means.

Preferably, the first and second upper side views are centered substantially at 45 degrees relative to the axis of rotation.

Preferably, each image capture means receives light via a first and a second optical path, wherein:

the first optical path includes a single reflecting element that receives light from one of said upper side views and directs light received to the image capture means; and

the second optical path includes a first and a second reflecting element, the first reflecting element positioned to receive light from said top view and direct it to the second reflecting element, which redirects the light received to the image capture means, wherein the second reflecting element is located substantially immediately adjacent to said first optical path.

Preferably, the image capture means has its optical axis centered on a line that bisects said first and second optical paths.

Preferably, the first and second optical paths have substantially equal path length.

Preferably, said conveying means may include two or more lanes for conveying articles past said imaging system and wherein the apparatus includes processing means operable to distinguish in images taken by said first and second image capture means articles in each lane.

According to a second aspect of the present invention, there is provided an article inspection apparatus including two or more article inspection apparatus as claimed in any one of the preceding claims located side by side with the respective first and second image capture means of each article inspection apparatus substantially in line with each other.

Preferably, the apparatus includes light sources arranged along both sides of each conveying means equidistant from the conveying means, with the light sources between said conveying means located substantially on a vertical plane that intersects the mid-point between the conveying means.

Preferably, said light sources include at least one light source on a first side of a first conveying means located at a height so as to have a clear line of sight to articles on a second conveying means adjacent to the first conveying means on the opposite side from said first side.

Preferably, said one or more light sources include at least one light source located approximately in a horizontal plane from articles when located on said conveying means.

Preferably, the at least one light source located approximately in a horizontal plane from articles includes a light source above the equator of the article and a light source below the equator of the article.

Preferably, the light sources are positioned to provide substantially uniform lighting over a spherical surface commensurate with the expected size of articles to be inspected.

Preferably, said one or more lighting sources are fluorescent tubes extending parallel to the conveying means.

According to a third aspect of the present invention, there is provided a method of article inspection including:

conveying an article through an inspection site and rotating the article about an axis as it passes through the inspection site;

using a first image capture device, viewing a top view and a first upper side view of an article as it passes through the inspection site;

using a second image capture device, viewing a top view and a second upper side view of an article as it passes through the inspection site, the second upper side view opposing said first upper side view.

Preferably, the method includes dividing the total area viewed by each of the first and second image capture devices between said top view and upper side view dependent on the shape of articles to be inspected.

Preferably, the method includes viewing less of the upper side view and more of the top view for ellipsoidal shaped objects.

Preferably, the method includes analyzing segments of images from said first and second image capture devices, the segments collectively defining the entire top view of the article as it passes through the inspection site substantially without overlap or omission of portions of the surface of the article.

Further aspects of the present invention, which should be considered in all its novel aspects, may become apparent from the following description, given by way of example only with reference to the accompanying drawings.

### BRIEF DESCRIPTION OF DRAWINGS

FIG. 1: Shows an imaging system forming part of an article inspection apparatus according to an aspect of the present invention.

FIG. 2: Shows an article inspection apparatus incorporating two imaging systems of FIG. 1.

FIG. 3: Shows a side view of the article inspection apparatus of FIG. 2.

FIG. 4: Shows an article inspection apparatus including multiple conveyors and associated imaging systems according to an embodiment of the present invention.

FIG. 5: Shows an article processing line including multiple dual conveyors and associated imaging systems according to another embodiment of the present invention.

### MODES FOR CARRYING OUT THE INVENTION

The present invention relates to an apparatus and method for inspecting the surface of articles. The present invention may have application to the detection of features on the surface of fruit, vegetables or other articles for grading purposes. In particular, the present invention is envisaged to be particularly suited to the analysis of the surface of opaque articles that have a generally circular cross section along at least one axis so that the article may be relatively easily rotated about that axis. Therefore, the present invention may have particular application to articles such as oranges, apples, lemons and other articles having a similar shape. However, those skilled in the relevant arts may find applications of the present invention elsewhere.

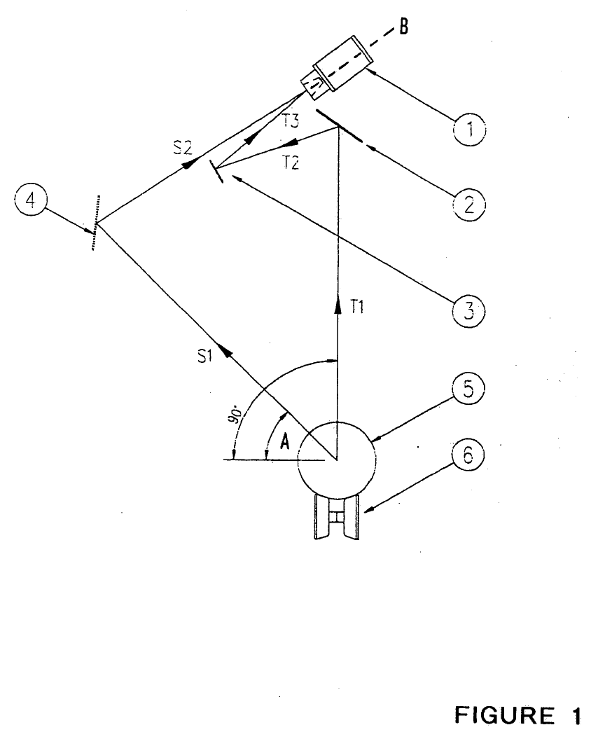

Referring first to FIG. 1, part of an imaging system according to the present invention is shown. The imaging system includes suitable image capture means, for example a camera 1 to receive light from an article 5. The camera 1 may be a standard CCD colour camera. The camera 1 receives light via a first and a second optical path, represented by S1, S2 and T1, T2, T3 respectively. The camera 1 therefore has a field of view that includes both a top view and an upper side view of the article 5. Mirrors 2, 3 and 4 are provided to guide light from the article 5, which has been located at an inspection site, to the camera 1. Optical paths S1, S2 and T1, T2, T3 preferably have equal path lengths to ensure an equal degree of focus for images acquired on both paths. For simplicity, the mirrors 2, 3 and 4 preferably have zero curvature.

The articles are carried through the inspection site on a conveying means such as the conveyor 6, which rotates the article 5 during inspection. The conveying means may achieve this rotation through the provision of a number of substantially equally spaced rollers. A suitable conveyor for this purpose is described in international publication number WO 94/14547, which may also be used to direct graded articles to specific locations under the control of a suitable controller. Other conveying means such as individual trolleys may be used if required.

In an alternative embodiment, the mirrors 2, 3 may be removed and a second camera provided to look substantially straight down on the article. Mirror 4 may also be omitted and the camera 1 moved into the position of mirror 4. This embodiment may be required if higher resolution was required, the additional resolution obtained at the cost of having to provide twice as many cameras.

In the preferred embodiment, the camera 1, through mirrors 2, 3 views the top of the article 5, and also views a side portion of the article through mirror 4. Mirror 4 is located relative to the article 5 at an angle A to the horizontal. The angle A is preferably approximately 45°, although variations on this angle may be used if required. The camera 1 may also be directed at an angle relative to the horizontal, and preferably has its optical axis B bisecting the path of the light rays S2 and T3. The arrangement shown in FIG. 1 may have particular advantage as a simple, reliable and cost effective way to obtain two views of an article using a single camera. A vertical orientation of camera may be used with an appropriate system of mirrors, for example by providing an additional mirror to mirrors 2, 3 and 4 that redirects the light to a vertical direction prior to receipt by the camera.

The top edge of the mirror 3 is preferably located in line with the optical axis B of the camera 1. This ensures that the image seen by the camera 1 is equally split between the top view (optical path T1, T2, T3) and the upper side view (optical path S1, S2) and therefore both views are given equal importance. This arrangement may be particularly suited to the viewing of generally spherical articles. For non-spherical objects, such as lemons that have an ellipsoidal shape, the mirror 3 may be moved upwards so that a greater proportion of the top view is seen relative to the upper side view.

Those skilled in the art will recognize that baffling, aperture stops and the like may be added to the system to prevent stray light entering the camera 1 from other sources. Also support structures will be provided to locate the mirrors 2, 3, 4 and camera 1 in position above the conveyor 6. The support structures may be of any suitable form that does not interfere with the optical paths from the article 5 to the camera 1 and also does not interfere with the lighting of the articles.

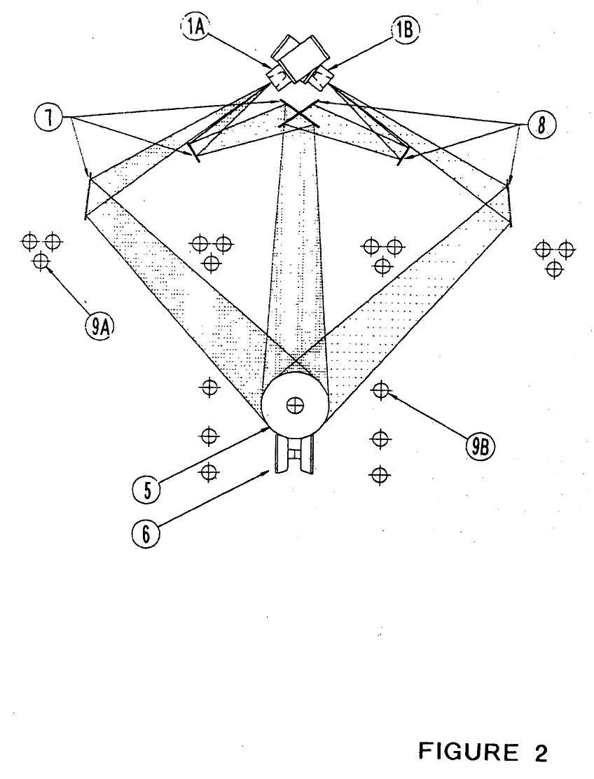

Referring now to FIG. 2, an imaging system including two cameras 1A, 1B is shown. Each camera 1A, 1B includes an associated optical system 7 and 8 respectively to provide a field of view on to the surface of the article 5. Optical systems 7 and 8 include mirrors 2, 3, 4 as shown in FIG. 1, with optical system 8 simply being a mirror of optical system 7. Each of the optical systems 7, 8 have two optical paths, and the mirrors 2, 3, 4 are located and oriented so that an image of the article 5 from both optical paths is formed at a common objective.

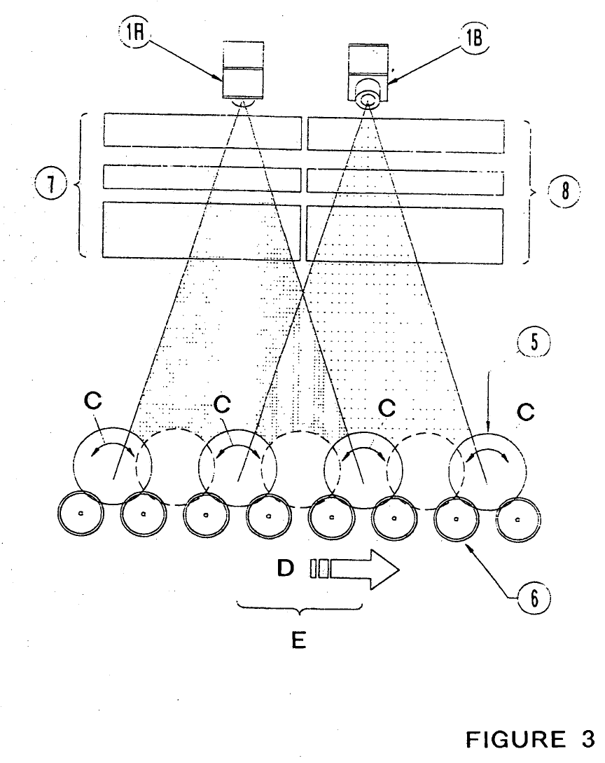

By having two optical paths, an increased surface area of the article 5 may be viewed by a single camera. In addition, as each optical path intersects the article 5 at an angle that is substantially normal to the fruit surface, the effects due to the spherical shape of the article 5 are reduced. Furthermore, with two cameras arranged as shown in FIGS. 2 and 3, three different optical paths, each at a different angle to the article 5 are provided. In combination with rotation of the article 5 on the conveyor 6, all of the surface of the article 5 may be viewed. This may be particularly advantageous for fruit, when features such as defects (for example cuts or splits) of less than one millimeter across may affect the fruit's grade. Such small defects may easily be missed if the system does not view the entire surface of the fruit.

As best seen from FIG. 2, each field of view overlaps significantly with its adjacent field of view to the extent that for most articles two views of the portion of the article 5 to be analyzed are captured at each stage of rotation. This may be advantageous during image analysis. For example both cameras 1A and 1B, will take multiple images of any surface features as the article 5 travels along the conveyor. In addition, almost all surface features will be seen by the camera from the upper side view and top view. A processing means 10 may then select the best image or images for analysis purposes, the selection process being performed according to some predetermined criteria, which may include the size and position the feature occupies in the image. Using only the best images for analysis purposes may increase the reliability of the feature identification process.

While in the system shown in FIG. 2, a significant overlapping view of the article 5 around its circumference is provided, less degrees of overlap may be used if required. In the limit, to view the entire surface of the article 5, each camera 1A and 1B may view only an upper quarter of the surface of the article 5. If all articles 5 where the same size, and rotated about an axis perpendicular to the conveyor 6, all the surface of the article would then be viewed. However, portions of articles such as fruit would likely be missed due to irregularities in the shape and dimensions of the article. Therefore, it is preferred that the fields of view overlap around the circumference of the article 5 and as described herein above in the preferred embodiment there is significant view overlap so that two views are obtained of all or substantially all portions of the surface of the article 5.

Light sources, two sets of which are marked 9A and 9B in FIG. 2 are provided to illuminate the article 5 so that the cameras 1A, 1B may adequately detect the surface characteristics of the article 5. The light sources may be fluorescent tubes extending longitudinally along the conveyor 6 and located so as to not obscure the article from the cameras 1A and 1B. The positioning of the light sources is described in more detail herein below.

Referring to FIG. 3, a side view of the imaging system of FIG. 2 is shown. The conveyor 6, which in this embodiment is a traveling set of rotating wheels, causes each article 5 passing through the inspection region I to rotate about an axis F, as indicated by arrow C. The articles 5 may rotate in either direction. The speed of rotation of the articles 5 is controlled by the conveyor 6, so that each article 5 completes at least one complete revolution while it is in the field of view of the two cameras 1A, 1B. To avoid excessive repetition of image processing, the article 5 is preferably rotated through less than two complete revolutions while in the field of view of the two cameras 1A, 1B. How much the article 5 rotates will depend on its circumference and therefore, the speed of rotation and/or speed of travel will be based on the average size or maximum expected size of articles to be inspected.

The fields of view of the cameras 1A, 1B are separated along the path of the conveyor 6 so that each camera views the article 5 when it is in a different position along the conveyor 6. Therefore, if the conveyor 6 travels in direction D, camera 1A first views the article 5, followed by camera 1B. The cameras 1A and 1B are preferably positioned to have an overlap E to prevent any part of the surface of the articles 5 being missed.

A processing means 10, such as a digital signal processor, microprocessor or similar receives the information from the cameras 1A and 1B and tracks the movement of the article 5 from the view of camera 1A into the view of camera 1B. Sequences of images from camera 1A and camera 1B form a composite image of the surface of the article. The processing means analyses a band from the image of each frame taken by the cameras 1A and 1B. By rotating the article 5 while it is within the field of view of each camera, a full picture of the entire surface of the article 5 may be obtained.

Regarding the top views from each of the cameras 1A and 1B only, while processing images from only one camera, the processing means 10 need only process a constant-sized region of each top view image it acquires. The width W of this region is equal to the product of the rotational speed and the camera imaging period. It is independent of the rotational diameter of the article 5. A larger article will take longer to complete a full rotation than a small article, but the width of each region processed is the same.

The processing means 10 may use geometric and timing considerations to identify the top view images from each of the cameras 1A, 1B that should be analyzed. The sequence of side view images from each camera will contain substantially the same region near the article's axis of rotation, repeated from many perspectives. Therefore, analysis of the side view images of the article 5 may be formed by averaging over the image sequence. Alternatively, the analysis of the side view images may be formed by selecting one or more images from the image sequence, or extracting segments from each image to create a composite image.

When processing of the top views transfers from the camera 1A to camera 1B, the width of either the last region processed from camera 1A, or the first region processed from camera 1B, or both, will not be the normal width W. An adjusted width W′ may be calculated taking into account factors such as the camera height, separation and viewing angles (parallax), the overlap distance between the camera fields of view, the rate at which the processing means acquires images from the cameras, the linear and rotational speeds of the article, the size, shape and curvature of the article, and so on. The value of W′ is highly dependent on the specific geometry of the imaging system, conveying system, and articles. The degree of precision required in establishing W′ will also vary between applications, allowing a variety of approximations, or even non-geometrical techniques (for example image correlation), in its calculation.

In one embodiment, the height of the cameras above the conveyor is established through a calibration process. The fields of view of the cameras 1A and 1B are also aligned so as to overlap by a predetermined distance E. The overlap distance should be as small as possible to gain the maximum viewing area over the conveyor region, but must be large enough to see the relevant parts of the article 5, according to the inspection requirements. For example shape, size and volume measurements all require a complete view of the article, whereas surface colour measurements on a region of the article may be obtained from viewing that region only. The minimum required distance E can be determined by determining the required distance that an article must travel into the field of view of a camera before image processing starts on it, taking into account the effect of parallax. This calculation should be determined for the largest diameter article expected to be viewed, and the processing means 10 can increase the time between switching to camera 1B for articles that have a smaller diameter than the maximum expected diameter.

Calibration of the camera height and other parameters may be performed by a process such as that described in “An Efficient and Accurate Camera Calibration Technique for 3D Machine Vision”, Roger Y. Tsai, Proceedings of IEEE Conference on Computer Vision and Pattern Recognition, Miami Beach, Fla., 1986, pages 364-374. After such a calibration process, the overlap distance E can be converted to an equivalent distance e within each camera image. With one camera in a fixed position, and viewing a target line that appears a distance e/2 in from the edge of its field of view, the second camera can be moved to achieve the correct overlap by aligning it so that it too views the same target line a distance e/2 in from the edge of its field of view. The processing means 10 may display images from each camera, overlaid with lines a distance e/2 from the image edges to facilitate this process. The target line is first moved to coincide with the overlay line displayed for camera 1A, then camera 1B is moved so that its overlay line coincides with the target line.

The processing means 10 is then used to track the article 5 through the field of view of camera 1A, calculate when it will appear at a suitable position in the field of view of camera 1B, and thereby determine the point at which processing should transfer from one camera to the other. Establishing this timing is critical to determining how far the article 5 will move and rotate before camera 1B views it, and therefore to what regions on its surface have already been viewed and analyzed from camera 1A. This calculation determines the width W′ to be used in the last image from the camera 1A and/or the first image from the camera 1B.

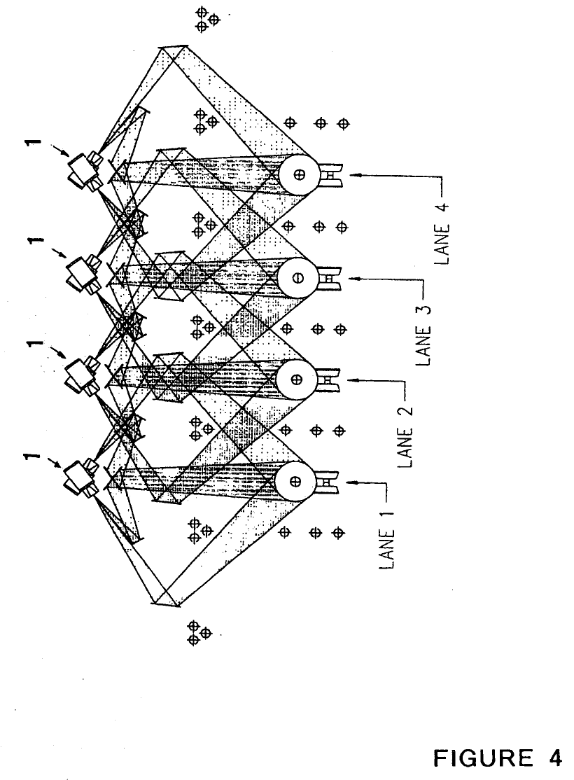

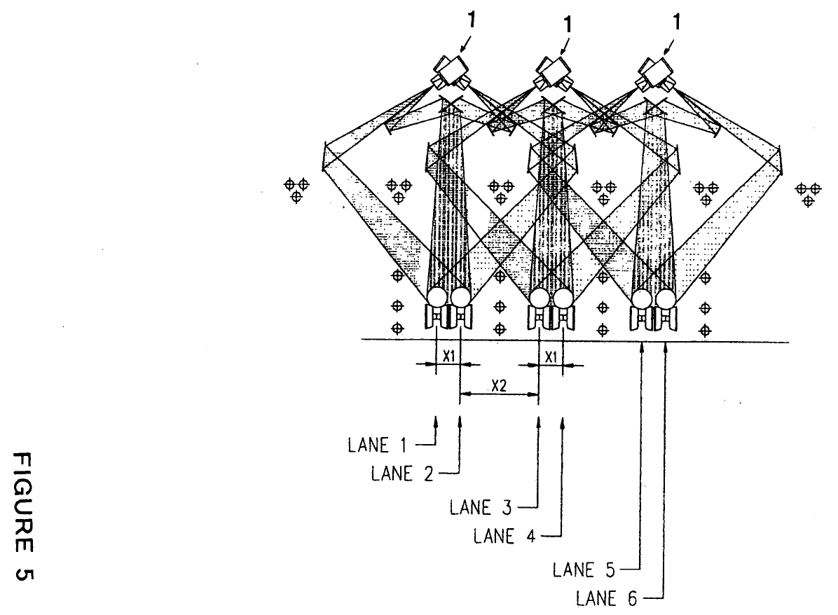

FIG. 4 shows an embodiment of a multiple conveyor system. Each conveyor forms its own lane, and each has associated with it a pair of cameras 1. Each lane operates in the same way as for the system shown in FIGS. 2 and 3. FIG. 5 shows an alternative multiple lane embodiment, where each conveyor has two lanes. The system described above in relation to FIGS. 2 and 3 may be used to view each pair of lanes and the image processing means programmed to separate the articles into distinct images for processing. The distance X1 between lanes in a pair should be sufficiently large so that articles in one lane do not overly obscure the view of articles in the other lane. The distance X2 between pairs of lanes should be selected so that the mirrors and associated support structures for one lane pair do not obscure the view of the cameras in another lane pair.

Light sources are provided to illuminate the article 5. The light sources preferably provide substantially uniform lighting over the article 5 along the full length of the combined camera fields of view through which the inspected article 5 moves and rotates. The lighting is preferably uniform on the surface of the articles and is not necessarily uniform on the flat conveyor surface or plane. By providing uniform lighting, artificial bright patches on the items caused by non-uniform lighting are avoided which may be confused with natural bright patches. The light sources must also provide enough light to get adequately bright images of the articles 5 at the conveying speed and rotation speeds required, since short exposure times may be required to reduce motion blur effects.

Referring to FIG. 4, the light sources 90-92, 93A,B and 94A,B are all located substantially on a vertical plane that bisects the lanes, with additional lights, such as light source 95 located at each side of the lane group. The lights are provided on both sides of each lane equidistant from the lane in order to ensure substantially equal lighting on both sides of each article. In order to illuminate the articles as much as possible with the given light sources, light from one lane is also used to illuminate the next lane. For example, light source 90 is positioned so that it has a clear line of sight to lane 2. Similarly, light source 92 has a clear line of sight to lane 1. By raising the height of light sources 90-92, light may reach to further lanes across the apparatus. To better illuminate the sides of the articles 5, light sources 93A, 93B and 94A, 94B are located beside the article 5. The vertical position and separation of light sources 93A, 93B and 94A, 94B is selected to provide as uniform light as possible over the surface of a typical article 5 and to achieve this, there is preferably at least one light above and one light below the equator of the article 5.

The cameras and mirrors may be enclosed in a positive pressure enclosure that is supplied by filtered air to reduce the need to clean the mirrors and lenses. As the mirrors 2, 3, 4 and cameras 1 are located substantially above the line of the articles 5, the amount of dirt and other contaminants that can be expected to reach the mirrors or the enclosure may be reduced. Each field of view includes only three mirrors to obtain substantially overlapping views that can be combined to form a single image of the entire surface of the article 5.

Where in the foregoing description reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

1. An article inspection apparatus including:
conveying means for conveying an article through an inspection site and rotating the article about an axis of rotation when the article is in the inspection site;
an imaging system including at least one image capture means as to view from above over a plurality of separate optical paths an article on the conveying means and all components of the imaging system are located separated from and above the conveying means; and
an illumination system arranged to illuminate the article on the conveying means from above and from the side.

2. The article inspection apparatus of claim 1, wherein the imaging system includes first and second image capture means that are spaced apart along the direction of travel of the conveying means.

3. The article inspection apparatus of claim 2, including processing means to analyse images received from the first and second image capture means, the processing means analysing segments of a top view of the article from images captured at different stages of rotation of the article, the segments having dimensions so as to substantially avoid any overlap between segments.

4. The article inspection apparatus of claim 3, wherein the field of view of the first image capture means overlaps with the field of view of the second image capture means along the conveying means to an extent sufficient to enable the processing means to identify in the view of the second image capture means the last segment analysed from the first image capture means, and in this way identify an appropriate first segment to analyse from images from the second image capture means so that a substantially continuous picture of the surface of the article results by combining analysed segments from the first and second image capture means.

5. The article inspection apparatus of claim 4, wherein the extent of overlap is substantially the minimum to maintain said continuous picture of the surface of the article.

6. The article inspection apparatus of claim 4, wherein the processing means alters the dimensions of either or both of the last segment from the first image capture means and the first segment from the second image capture means in order to maintain said continuous picture of the surface of the article.

7. The article inspection apparatus of claim 1, including processing means operable to receive plural images from said image capture means and from said plural images identify a marking on the article, wherein the processing means then selects at least one image of said marking for analysis purposes according to predetermined criteria.

8. The article inspection apparatus of claim 2, wherein the conveying means rotates the article at a speed so that it completes at least one complete revolution, but less than two complete revolutions while within combined fields of view of the first and second image capture means.

9. The article inspection apparatus of claim 1, wherein the imaging system has a field of view including opposing first and second upper side views of an article located on the conveying means.

10. The article inspection apparatus of claim 9, including two image capture means and wherein each image capture means receives light via a first and a second optical path, and wherein:
the first optical path includes a single reflecting element that receives light from one of said upper side views and directs light received to the image capture means; and
the second optical path includes a first and a second reflecting element, the first reflecting element positioned to receive light from said top view and direct it to the second reflecting element, which redirects the light received to the image capture means, wherein the second reflecting element is located substantially immediately adjacent to said first optical path.

11. The article inspection apparatus of claim 10, wherein the image capture means has its optical axis centred on a line that bisects said first and second optical paths.

12. The article inspection apparatus of claim 10 wherein the first and second optical paths have substantially equal path length.

13. The article inspection apparatus as claimed claim 1, wherein said conveying means includes two or more lanes for conveying articles past said imaging system and wherein the apparatus includes processing means operable to distinguish in images taken by said first and second image capture means articles in each lane.

14. An article inspection apparatus including two or more article inspection apparatus as claimed in claim 1 located side by side with the respective image capture means of each article inspection apparatus substantially in line with each other.

15. The article inspection apparatus of claim 14 wherein the illumination system includes light sources arranged along both sides of each conveying means equidistant from the conveying means, with the light sources between said conveying means located substantially on a vertical plane that intersects the mid-point between the conveying means.

16. The article inspection apparatus of claim 15, wherein said light sources include at least one light source on a first side of a first conveying means located at a height so as to have a clear line of sight to articles on a second conveying means adjacent to the first conveying means on the opposite side from said first side.

17. The article inspection apparatus of claim 15 wherein the illumination system includes at least one light source located approximately in a horizontal plane from articles when located on said conveying means.

18. The article inspection apparatus of claim 17 wherein the at least one light source located approximately in a horizontal plane from articles includes a light source above the equator of the article and a light source below the equator of the article.

19. The article inspection apparatus of claim 17, wherein the light sources are positioned to provide substantially uniform lighting over a spherical surface commensurate with the expected size of articles to be inspected.

20. The article inspection apparatus of claim 15 wherein said one or more lighting sources are fluorescent tubes extending parallel to the conveying means.

21-26. (Previously Cancelled).

27. The article inspection apparatus of claim 1, wherein the imaging system and illumination system do not share any common optical components.

28. The article inspection apparatus of claim 1, wherein the plurality of separate optical paths have substantially equal optical path lengths.

29. The article inspection apparatus of claim 9, wherein the first and second upper side views are centred substantially at 45 degrees relative to the axis of rotation.

30. The article inspection apparatus of claim 9, wherein the imaging system has a field of view including a top view of an article located on the conveying means.

31. A method of article inspection including:
conveying an article through an inspection site and rotating the article about an axis when it is in the inspection site;
illuminating the article from above and from the side at least when it is in the inspection site;
when the article is illuminated, viewing the article from above through a plurality of separate optical paths, using only optical components located separate from and above the article.

32. The method of claim 30, including viewing the article from the top and from opposing upper side views.

33. The method of claim 32, including dividing the total field of view between the top view and upper side views dependent on the shape of articles to be inspected.

34. The method of claim 33, including viewing less of the upper side view and more of the top view when ellipsoidal shaped objects are to be inspected.

35. The method of claim 31, wherein the plurality of separate optical paths have a substantially equal path length.

36. The method of claim 31, wherein the optical components used in the step of viewing the article are separate from any components used in the step of illuminating the article.

37. An article inspection apparatus including:
a conveying device for conveying an article through an inspection site and rotating the article about an axis of rotation when the article is in the inspection site;
an imaging system including at least one image capture device viewing the article through multiple optical paths comprising a first optical path having a first reflecting element to direct light from a first upper view of the article to the image capture device and a second optical path having second and third reflecting elements, the second reflecting element receiving light from a second upper view of the article and directing received light to the third reflecting element and the third reflecting element directing light to the image capture device;
wherein the first, second and third reflecting elements are positioned separated from and above the conveying device.

38. The article inspection apparatus of claim 37, wherein the imaging system includes an image capture device that views the article through a third optical path having a fourth reflecting element, the fourth reflecting element receiving light from a third upper view of the article and directing received light to the image capture device.

39. The article inspection apparatus of claim 38, wherein the imaging system includes an image capture device that views the article through a fourth optical path having fifth and sixth reflecting elements, the fifth reflecting element receiving light from a fourth upper view of the article and directing received light to the sixth reflecting element and the sixth reflecting element directing light to the image capture device.

40. The article inspection apparatus of claim 39, wherein both the second the fourth upper views are views of the top of the article and the second and fourth optical paths are separated along the path of the conveying device.

41. The article inspection apparatus of claim 39, including first and second image capture devices, the first image capture device viewing the article through said first and second optical paths and the second image capture device viewing the article through said third and fourth optical paths.

42. The article inspection apparatus of claim 37, wherein the first and third upper views are views of opposing upper sides of the article the said second and fourth views are top views of the article.

43. An article inspection apparatus including:
conveying means for conveying an article through an inspection site and rotating the article about an axis of rotation as it passes through the inspection site;
an imaging system including an image capture means and a mirror arrangement that defines the field of view of said image capture means,
characterized in that
the imaging system is arranged so that the image capture means has a field of view including a top view and a first upper side view of an article on said conveying means, wherein the components of the imaging system and mirror arrangement are located separated from and above the conveying means.

44. The article inspection apparatus of claim 43, including a further imaging system having a second image capture means that has a field of view including a top view and second upper side view of said article, wherein said second upper side view opposes said first upper side view.

45. The article inspection apparatus of claim 44, wherein the first and second upper side views are centered substantially at 45 degrees relative to the axis of rotation.

46. The article inspection apparatus of claim 44, wherein the first and second image capture means are spaced apart along the direction of travel of the conveying means.

47. The article inspection apparatus of claim 46, including processing means to analyze images received from the first and second image capture means, the processing means analyzing segments of the top view of the article from images captured at different stages of rotation of the article, the segments having dimensions so as to substantially avoid any overlap between segments.

48. The article inspection apparatus of claim 47, wherein the field of view of the first image capture means overlaps with the field of view of the second image capture means along the conveying means to an extent sufficient to enable the processing means to identify in the view of the second image capture means the last segment analyzed from the first image capture means, and in this way identify an appropriate first segment to analyze from images from the second image capture means so that a substantially continuous picture of the surface of the article results by combining analyzed segments from the first and second image capture means.

49. The article inspection apparatus of claim 48, wherein the extent of overlap is substantially the minimum to maintain said continuous picture of the surface of the article.

50. The article inspection apparatus of claim 48, wherein the processing means alters the dimensions of either or both of the last segment from the first image capture means and the first segment from the second image capture means in order to maintain said continuous picture of the surface of the article.

51. The article inspection apparatus of claim 44, wherein the conveying means rotates the article at a speed so that it completes at least one complete revolution, but less than two complete revolutions while within combined fields of view of the first and second image capture means.

52. The article inspection apparatus of claim 44, including processing means operable to receive plural images from said image capture means and from said plural images identify a marking on the article, wherein the processing means then selects an image of said marking for analysis purposes according to predetermined criteria.

53. The article inspection apparatus of claim 44, wherein each image capture means receives light via a first and a second optical path, and wherein:
the first optical path includes a single reflecting element that receives light from one of said upper side views and directs light received to the image capture means; and
the second optical path includes a first and a second reflecting element, the first reflecting element positioned to receive light from said top view and direct it to the second reflecting element, which redirects the light received to the image capture means, wherein the second reflecting element is located substantially immediately adjacent to said first optical path.

54. The article inspection apparatus of claim 53, wherein the image capture means has its optical axis centered on a line that bisects said first and second optical paths.

55. The article inspection apparatus of claim 53 wherein the first and second optical paths have substantially equal path length.

56. The article inspection apparatus of claim 44, wherein said conveying means includes two or more lanes for conveying articles past said imaging system and wherein the apparatus includes processing means operable to distinguish in images taken by said image capture means articles in each lane.

57. An article inspection apparatus including two or more article inspection apparatus as claimed in claim 44 located side by side with the respective image capture means of each article inspection apparatus substantially in line with each other.

58. The article inspection apparatus of claim 57 including light sources arranged along both sides of each conveying means equidistant from the conveying means, with the light sources between said conveying means located substantially on a vertical plane that intersects the mid-point between the conveying means.

59. The article inspection apparatus of claim 58, wherein said light sources include at least one light source on a first side of a first conveying means located at a height so as to have a clear line of sight to articles on a second conveying means adjacent to the first conveying means on the opposite side from said first side.

60. The article inspection apparatus of claim 59 wherein said one or more light sources include at least one light source located approximately in a horizontal plane from articles when located on said conveying means.

61. The article inspection apparatus of claim 60 wherein the at least one light source located approximately in a horizontal plane from articles includes a light source above the equator of the article and a light source below the equator of the article.

62. The article inspection apparatus of claim 61, wherein the light sources are positioned to provide substantially uniform lighting over a spherical surface commensurate with the expected size of articles to be inspected.

63. The article inspection apparatus of claim 62 wherein said one or more lighting sources are fluorescent tubes extending parallel to the conveying means.

64. A method of article inspection including:
conveying an article through an inspection site and rotating the article about an axis as it passes through the inspection site; and
using an image capture device and a mirror arrangement both located separated from and above the plane through which the article is conveyed through the inspection site, viewing a top view and a first upper side view of an article as it passes through the inspection site.

65. The method of claim 64 further including using a second image capture device, viewing a top view and a second upper side view of an article as it passes through the inspection site, the second upper side view opposing said first upper side view.

66. The method of claim 65 including dividing the total area viewed by each of the first and second image capture devices between said top view and upper side view dependent on the shape of articles to be inspected.

67. The method of claim 66 including viewing less of the upper side view and more of the top view for ellipsoidal shaped objects.

68. The method of any claim 64 including analyzing segments of images from said image capture devices, the segments collectively defining the entire top view of the article as it passes through the inspection site substantially without overlap or omission of portions of the surface of the article.
